(19) United States
(12) Patent Application Publication
(10) Pub. No.: US 2018/0343582 A1
(43) Pub. Date: Nov. 29, 2018

(54) CONGESTION CONTROL METHOD AND APPARATUS

(71) Applicant: Huawei Technologies Co., Ltd., Shenzhen (CN)

(72) Inventors: Yuan WANG, Shanghai (CN); Fenqin ZHU, Shanghai (CN); Lin SHU, Shanghai (CN)

(21) Appl. No.: 16/037,478

(22) Filed: Jul. 17, 2018

Related U.S. Application Data
(63) Continuation of application No. PCT/CN2016/071306, filed on Jan. 18, 2016.

(51) Int. Cl. H04W 28/02; H04L 12/851; H04W 48/14; H04W 48/06; H04W 28/08

(52) U.S. Cl. CPC H04W 28/0289; H04W 28/0247; H04L 47/2408; H04W 48/18; H04W 48/06; H04W 28/08; H04W 48/14

(57) ABSTRACT

The present invention discloses a congestion control method and apparatus. A priority of a DCN type supported by a core network is defined. When a DCN node is congested, congestion control may be first performed on a DCN type having a low priority. Therefore, access by UE of the DCN type having a low priority is prevented, and normal access by UE of a DCN type having a high priority can be ensured. In addition, it can be avoided that the DCN node monitors a load status of each supported DCN type, thereby reducing policy complexity of the DCN node. Furthermore, it is avoided that the DCN node is not congested but a particular type of DCN is congested, thereby improving resource usage.

### CROSS-REFERENCE TO RELATED APPLICATIONS

This application is a continuation of International Application No. PCT/CN2016/071306, filed on Jan. 18, 2016, the disclosure of which is hereby incorporated by reference in its entirety.

### TECHNICAL FIELD

The present invention relates to the field of communications technologies, and in particular, to a congestion control method and apparatus.

### BACKGROUND

As mobile communications networks evolve and applications having different communications characteristics emerge, UEs (User Equipment, user equipment) of different communications types appear. Therefore, operators provide a solution of separately deploying DCNs (Dedicated Core Network, dedicated core network) for the UEs of different communications types. When requesting to access a DCN, UE sends an access request to a connected RAN (Radio Access Network, radio access network) node, where the access request carries a type of the DCN that the UE requests to access. The RAN node determines, based on the DCN type reported by the UE, whether the DCN type is a DCN type over which congestion control is performed, and if it is determined that the DCN type is a DCN type over which congestion control is performed, rejects access by the UE.

In the prior art, a DCN node determines a DCN type over which congestion control needs to be performed. Specifically, the DCN node monitors a load status of each DCN type currently supported, determines to perform congestion control over a DCN type meeting a congestion condition, and notifies a RAN node of the DCN type over which congestion control is performed, so that the RAN node rejects access by UE corresponding to the DCN type. The manner of monitoring, by the DCN node, a load status of each DCN type increases resource overheads. In addition, because a core network resource occupied by each DCN type is exclusively occupied, the DCN node performs congestion control over the DCN type meeting the congestion control condition. In the solution of the prior art, if a DCN over which congestion control is performed provides a key basic service, for example, an automatic vehicle driving service, access to the DCN is also restricted. Consequently, UE cannot obtain the key basic service, and resource usage is reduced.

### SUMMARY

An embodiment of the present invention provides a congestion control method. A priority of a DCN type supported by a core network is defined. When a DCN node is congested, congestion control may be first performed on a DCN type having a low priority. Therefore, access by UE of the DCN type having a low priority is prevented, and normal access by UE of a DCN type having a high priority can be ensured. In addition, it can be avoided that the DCN node monitors a load status of each supported DCN type, thereby reducing policy complexity of the DCN node. Furthermore, it is avoided that the DCN node is not congested but a particular type of DCN is congested, thereby improving resource usage.

According to a first aspect, the present invention provides a congestion control method. A priority of a dedicated core network DCN type is obtained. A status of the DCN type is determined based on the priority of the DCN type. A type of a DCN that UE requests to access is obtained based on an access request message sent by the UE, to learn of a status of the type of the DCN that the UE requests to access. Finally, whether to allow access by the UE is determined based on the status of the type of the DCN that the UE requests to access.

In a possible design, a network load status may be first obtained, and the status of the DCN type is determined based on the priority of the DCN type and the network load status.

In a possible design, the network load status is a congestion grade. Therefore, the status of the DCN type may be determined based on the priority of the DCN type and the congestion grade.

In a possible design, a radio access network RAN node may receive the network load status sent by a DCN node.

In a possible design, the RAN node may determine the priority of the DCN type based on a service type supported by the DCN type or a pre-configuration of an operator; or the RAN node determines the priority of the DCN type based on DCN information sent by the DCN node.

In a possible design, the RAN node or the DCN node may obtain, from the access request message, the type of the DCN that the UE requests to access.

In a possible design, the DCN node has a capability of obtaining the network load status of the DCN node.

In a possible design, the DCN node obtains, from the access request message, the type of the DCN that the UE requests to access, or the dedicated core network DCN node obtains the DCN type of the UE from a home subscriber server HSS based on the access request message.

In a possible design, the DCN node may further determine the priority of the DCN type based on a service type supported by the DCN type or a pre-configuration of a network operator.

In a possible design, the RAN node or the DCN node may control access by the UE, for example, allow access by the UE if the status of the type of the DCN is the state of not performing congestion control, or skip allowing access by the UE if the status of the DCN type is the state of performing congestion control.

In a possible design, if the status of the type of the DCN is the state of performing congestion control, the RAN node or the DCN node obtains a priority of the UE based on the access request message, and determines, based on the priority of the UE, whether to allow access by the UE.

In a possible design, the determining, by the RAN node or the DCN node based on the priority of the UE, whether to allow access by the UE may be, for example: obtaining a priority of UE by which access is allowed; and if the priority of the UE is greater than or equal to the priority of the UE by which access is allowed, allowing access by the UE; or if the priority of the UE is less than the priority of the UE by which access is allowed, skipping allowing access by the UE.

According to a second aspect, the present invention provides a congestion control apparatus. The congestion control apparatus has a function of implementing actions performed by the congestion control apparatus in the foregoing method design. The function may be implemented by using hardware, or may be implemented by hardware executing corresponding software. The hardware or the software includes one or more modules corresponding to the foregoing function. The modules may be software and/or hardware. The congestion control apparatus includes an obtaining unit, a processing unit, and a receiving unit. The congestion control apparatus may be integrated in a RAN node, or may be integrated in a DCN node, and is configured to perform related steps of the RAN node or the DCN node in the congestion control method provided in the first aspect.

In a possible design, a structure of the congestion control apparatus includes a receiver, a transmitter, and a processor. The processor is configured to support the congestion control apparatus to implement a corresponding function in the foregoing method. The transmitter is configured to support the congestion control apparatus to communicate with UE. The congestion control apparatus may further include a memory. The memory is configured to be coupled to the processor. The memory stores necessary program instructions and data of the congestion control apparatus. The congestion control apparatus may further include a communications interface, used by the congestion control apparatus to communicate with another device or communications network.

According to a third aspect, the present invention provides a computer storage medium, configured to store a computer software instruction used by the foregoing congestion control apparatus. The computer software instruction includes a program designed to implement the foregoing aspects.

In the present invention, the DCN type mentioned above may be replaced with a UE type, a UE usage type, a UE service type, or one of all other names that can be used to indicate UEs having a same communications characteristic.

Compared with the prior art, access by UE of a DCN type having a low priority is prevented, and normal access by UE of a DCN type having a high priority can be ensured. In addition, it can be avoided that the DCN node monitors a load status of each supported DCN type, thereby reducing policy complexity of the DCN node. Furthermore, it is avoided that the DCN node is not congested but a particular type of DCN is congested, thereby improving resource usage.

### BRIEF DESCRIPTION OF DRAWINGS

To describe the technical solutions in the embodiments of the present invention more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of a system architecture according to one of embodiments of the present invention;

FIG. 2 is a schematic diagram of a computer device according to an embodiment of the present invention;

FIG. 3A and FIG. 3B are a schematic flowchart of a congestion control method according to a first embodiment of embodiments of the present invention;

FIG. 4 is a schematic flowchart of a congestion control method according to a second embodiment of embodiments of the present invention;

FIG. 5 is a schematic flowchart of a congestion control method according to a third embodiment of embodiments of the present invention; and

FIG. 6 is a schematic structural diagram of a congestion control apparatus according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

For ease of intuitive description, a DCN type is used as an example for description in the following embodiments. The DCN type is a type of a DCN node and is a type allocated by a network operator to the DCN node during network deployment, and is used to indicate a type of UE that can be served by the DCN node. A core network or a base station may select, based on the DCN type, a dedicated DCN that serves the type of UE. One DCN node may simultaneously serve multiple types of UEs. Therefore, one DCN node may be of multiple DCN types. A UE type is a type of UEs having a same communications characteristic or service characteristic, or may be referred to as a UE usage type (Usage Type), a UE service type, or all other names that can be used to indicate UEs having a same communications characteristic or service characteristic. The core network or the base station may select, based on the UE type, a dedicated DCN that serves the type of UE. In the following embodiments of the present invention, the DCN type may be replaced with the UE type, the UE usage type, the UE service type, or one of all the other names that can be used to indicate the UEs having a same communications characteristic. A solution obtained has an equivalent protection scope.

For ease of understanding of the present invention, the following first describes prior-art content related to the present invention. The 3GPP (the 3rd Generation Partnership Project, the 3rd Generation Partnership Project) establishes a specialized research project for DCN deployment, and provides the following requirements:

(1) DCN deployment does not affect implementation of existing UE.

(2) A new PLMN (Public Land Mobile Network, public land mobile network) identifier does not need to be introduced for DCN deployment.

(3) A same RAN node may share multiple different DCNs.

(4) UEs supporting multiple different DCN types may be simultaneously configured for a same RAN node. In an existing 3GPP communications system, an MME (Mobility Management Entity, mobility management entity) is a RAN node in a 4G architecture, and an SGSN (Serving GPRS Support Node, serving GPRS support node) is a RAN node in a 3G architecture.

(5) On a network deployed with a DCN, all MMEs need to support a function of a dedicated RAN node, and UE is registered with an MME corresponding to a DCN type.

(6) On a network deployed with a DCN, all MMEs need to redirect or switch UE to a proper DCN, and support transfer of DCN selection auxiliary information of UE between MMEs, so that the UE is registered with a DCN of a corresponding DCN type.

In the present invention, a priority of a DCN type is determined, based on the priority of the DCN type, a status of the DCN type is determined as a state of performing congestion control or a state of not performing congestion control, and when an access request sent by UE is received, a status of a type of a DCN that the UE requests to access is determined to determine whether to allow access by the UE. Therefore, when an entire DCN node is congested, congestion control may be first performed on a DCN type having a low priority. Therefore, access by UE of the DCN type having a low priority is prevented, and normal access by UE of a DCN type having a high priority can be ensured, thereby improving resource usage.

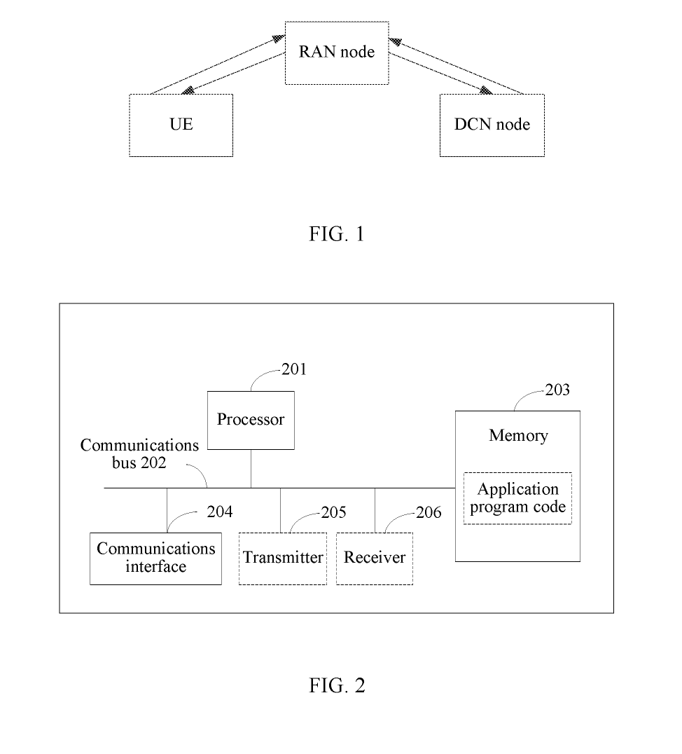

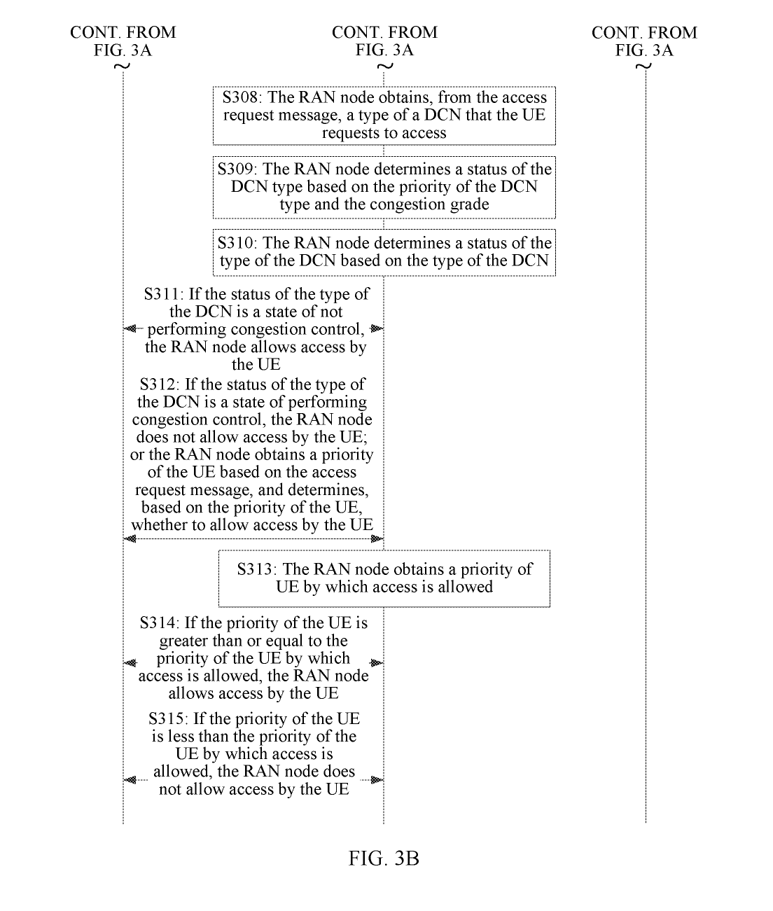

FIG. 1 is a schematic diagram of a system architecture according to one of embodiments of the present invention. The system architecture is applied to a dedicated core network scenario or a network sharing scenario of a 3GPP communications system. The following method procedures in FIG. 3A and FIG. 3B to FIG. 5 are implemented based on the system architecture. The system architecture shown in FIG. 1 includes a DCN node and a RAN node. Details are as follows:

A DCN is a dedicated core network. A DCN node is a node device on the DCN, and is configured to serve UEs of different communications types. In FIG. 1, for a type of UE having a same communications characteristic, an operator subscribes to a DCN type (DCN type), and deploys a dedicated DCN node including an MME, a data gateway, and the like, so that UEs of a same DCN type are registered with a DCN node deployed for the UEs in a dedicated manner. The DCN node may simultaneously be of multiple DCN types. This helps an operator to manage and maintain different types of UEs in a targeted manner. A dedicated network is used in a dedicated manner. This improves efficiency of mobility management and session management of access by a large number of UEs, and reduces network maintenance costs. In the present invention, a DCN may determine a priority of a DCN type, determine a status of the DCN type based on the priority of the current DCN type, and enable, based on a type of a DCN that is requested by UE, a RAN node to control access by the UE.

A RAN node is a radio access network node. In an EPS (Evolved Packet System, evolved packet system) architecture, a RAN node is an eNodeB (evolved base station). In a 3G communications system architecture, a RAN node is a NodeB (base station). A RAN node may also determine a priority of a DCN type, determine a status of the DCN type based on the priority of the current DCN type, and control, based on a type of a DCN that is requested by UE, access by the UE.

Optionally, the system architecture shown in FIG. 1 further includes UE. The UE is user equipment. In the present invention, access to a network may be requested, and a type of a to-be-accessed DCN that is requested is carried. If a status of the type of the to-be-accessed DCN that is requested is a state of performing congestion control, access to the DCN by the UE is rejected; if a status of the type of the to-be-accessed DCN that is requested is a state of not performing congestion control, access to the DCN by the UE is allowed.

In this embodiment of the present invention, the DCN node and the RAN node may coordinate with each other to participate in control over access by the UE. The following provides descriptions according to different embodiments.

In this embodiment of the present invention, a priority of a DCN type supported by a core network is defined. When the DCN node is congested, congestion control may be first performed on a DCN type having a low priority. Therefore, access by UE of the DCN type having a low priority is prevented, and normal access by UE of a DCN type having a high priority can be ensured. In addition, it can be avoided that the DCN node monitors a load status of each supported DCN type, thereby reducing policy complexity of the DCN node. Furthermore, it is avoided that the DCN node is not congested but a particular type of DCN is congested, thereby improving resource usage.

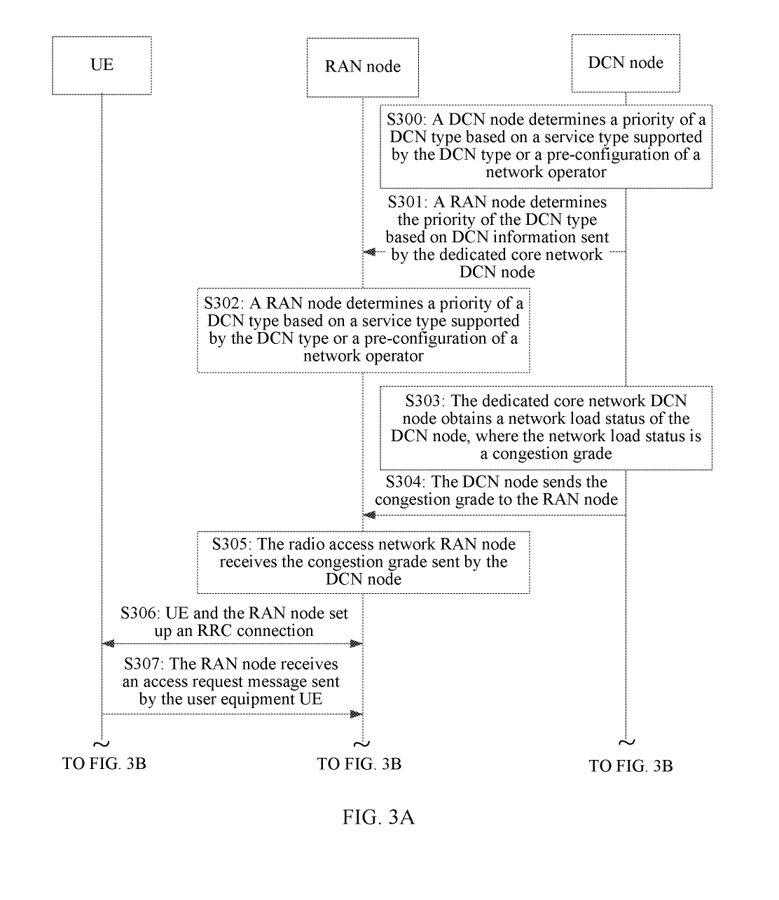

As shown in FIG. 2, the DCN node and the RAN node shown in FIG. 1 may be implemented in a form of a computer device (or a system) in FIG. 2.

FIG. 2 is a schematic diagram of a computer device according to an embodiment of the present invention. The computer device includes at least one processor 201, a communications bus 202, a memory 203, at least one communications interface 204, a transmitter 205, and a receiver 206.

The processor 201 may be a general-purpose central processing unit (CPU), a microprocessor, an application-specific integrated circuit (application-specific integrated circuit, ASIC), or one or more integrated circuits configured to control execution of a program of the solutions of the present invention.

The communications bus 202 may include a path, and transfer information between the foregoing components. The communications interface 204 uses any apparatus similar to a transceiver, to communicate with another device or a communications network such as Ethernet, a radio access network (RAN), or a wireless local area network (Wireless Local Area Network, WLAN).

The memory 203 may be a read-only memory (read-only memory, ROM) or another type of static storage device that can store static information and instructions, or a random access memory (random access memory, RAM) or another type of dynamic storage device that can store information and instructions; or may be an electrically erasable programmable read-only memory (Electrically Erasable Programmable Read-Only Memory, EEPROM), a compact disc read-only memory (Compact Disc Read-Only Memory, CD-ROM) or another optical disc storage, an optical disc storage (including a compressed optical disc, a laser disc, an optical disc, a digital versatile disc, a Blu-ray disc, and the like), a magnetic disk storage medium or another magnetic storage device, or any other mediums that can be used to carry or store expected program code in a form of an instruction or a data structure and that can be accessed by a computer. However, no limitation is posed thereon. The memory may exist independently, and is connected to the processor by using the bus. The memory may alternatively be integrated in the processor.

The memory 203 is configured to store application program code for executing the solutions of the present invention, and the processor 201 controls execution. The processor 201 is configured to execute the application program code stored in the memory 203.

When the computer device shown in FIG. 2 is a DCN node, on one hand, the code stored in the memory 203 may be used to perform the congestion control method provided in the present invention, for example, determine a priority of a DCN type, determine a status of the DCN type based on the priority of the current DCN type, and control, based on a type of a DCN requested by UE, access by the UE.

During specific implementation, in an embodiment, the computer device may further include the transmitter 205 and the receiver 206. The transmitter 205 communicates with the processor 201, and the receiver 206 communicates with the processor 201 and may receive, in multiple manners, signaling sent by the UE.

When the computer device shown in FIG. 2 is a RAN node, on another hand, the code stored in the memory 203 may be used to perform the congestion control method provided in the present invention, for example, determine a priority of a DCN type, determine a status of the DCN type based on the priority of the current DCN type, and control, based on a type of a DCN requested by UE, access by the UE.

During specific implementation, in an embodiment, the computer device may further include the transmitter 205 and the receiver 206. The transmitter 205 communicates with the processor 201, and the receiver 206 communicates with the processor 201 and may receive, in multiple manners, signaling sent by the UE or a DCN node.

The computer device may be a general-purpose computer device or a dedicated computer device. During specific implementation, the computer device may be a desktop computer, a portable computer, a network server, a personal digital assistant (Personal Digital Assistant, PDA), a mobile phone, a tablet computer, a wireless terminal device, a communications device, a built-in device, or a device of a structure similar to that in FIG. 2. In this embodiment of the present invention, a type of the computer device is not limited.

Referring to FIG. 3A and FIG. 3B, FIG. 3A and FIG. 3B are a schematic flowchart of a congestion control method according to a first embodiment of embodiments of the present invention. In the following embodiments, for ease of intuitive description, a type of a DCN node is referred to as a “DCN type” and is a UE type of UE served by the DCN node, and is used to indicate UEs having a same communications characteristic. A person skilled in the art shall understand that in the following embodiments, solutions obtained by replacing the DCN type with a UE type, a UE usage type, a UE service type, or one of all other names that can be used to indicate the UEs having a same communications characteristic are the same, and have an equivalent protection scope. It should be noted that one dedicated DCN node may simultaneously serve multiple types of UEs. Therefore, one DCN node may be of multiple DCN types.

A procedure of a congestion control method in this embodiment shown in FIG. 3A and FIG. 3B may include the following steps.

S300: A DCN node determines a priority of a DCN type based on a service type supported by the DCN type or a pre-configuration of a network operator.

Specifically, the DCN node defines a priority for each DCN type currently supported. A priority definition criterion is based on at least one of an actual commercial scenario, a specific service type, or a network policy. For example, the DCN node may support three DCN types: MBB (Mobile Broadband, mobile broadband), IoT (Internet of Things, Internet of Things), and V2V (Vehicle to Vehicle, vehicle to vehicle). Based on the at least one of the actual commercial scenario, the specific service type, or the network policy, the DCN node may define a high priority for a DCN whose DCN type is MBB, a low priority for a DCN whose DCN type is IoT, and an intermediate priority for a DCN whose DCN type is V2V. It should be understood that a priority is used to identify a relationship between priorities of DCNs supported by a current DCN node. In addition to the foregoing expression method, a form of values or other similar forms identifying priorities all fall within the protection scope of the present invention.

Optionally, DCN types supported by the DCN node are not limited to the foregoing three types, and other DCN types may also be supported, and are not described one by one in this embodiment.

S301: A RAN node determines the priority of the DCN type based on DCN information sent by the dedicated core network DCN node.

Specifically, the DCN node may notify the RAN node of the priority of the DCN type, for example, add a priority of each DCN type to the DCN information delivered to the RAN node, so that the RAN node can determine the priority of each DCN type. The DCN node may send the DCN information to the RAN node by using an S1 setup (S1 setup) process (for example, an S1 Setup Response (S1 setup response)) message already defined in a standard, or a newly defined exchange message. A sending form is not limited in this embodiment. The DCN information includes, but is not limited to, at least the DCN type of each DCN currently supported by the DCN node and the priority of the DCN type.

S302: A RAN node determines a priority of a DCN type based on a service type supported by the DCN type or a pre-configuration of a network operator.

Specifically, the RAN node may not need to determine the priority of the DCN type by using the DCN node, and the RAN node may define a priority for each DCN type based on at least one of an actual commercial scenario, a specific service type, or a network policy. The RAN node may obtain each DCN type supported by the DCN node, obtain a service type of each DCN type, and determine the priority of the DCN type based on at least one of the actual commercial scenario, the service type of each DCN type, or the network policy.

It should be noted that steps S300 and S301 are parallel to step S302. That is, step S303 may be performed after steps S300 and S301 are performed, or step S303 may be performed after step S302 is independently performed.

S303: The DCN node obtains a network load status of the DCN node, where the network load status is a congestion grade.

Specifically, when the entire DCN node on a network is congested, for example, the network load status of the DCN node reaches a preset load control threshold, the DCN node determines to perform congestion control, and obtains the network load status, where the network load status is the congestion grade. It should be understood that a congestion grade is used to identify a grade of congestion control that a current DCN node determines to perform. In addition to the foregoing expression method, a form of values or other similar forms identifying grades all fall within the protection scope of the present invention.

S304: The DCN node sends the congestion grade to the RAN node.

Specifically, the DCN node sends congestion control start information to the RAN node, where the congestion control start information includes a congestion level (congestion level) information element, used to indicate a current congestion grade, for example, a high grade, an intermediate grade, or a low grade. The congestion grade indicated by the congestion control start information depends on the network load status and the network policy. For example, a congestion grade carried in a congestion control message sent by the DCN node when a load reaches 80% may be low, and a congestion grade carried in a congestion control message sent by the DCN node when a load reaches 95% may be high.

S305: The radio access network RAN node receives the congestion grade sent by the DCN node.

Specifically, the RAN node receives the congestion control start information sent by the DCN node, obtains the congestion grade from the congestion control start information, and determines a congestion control degree.

S306: UE and the RAN node set up an RRC connection.

Specifically, the UE requests to access the RAN node, and sets up an RRC (Radio Resource Control, radio resource control) link to the RAN node.

S307: The RAN node receives an access request message sent by the user equipment UE.

Specifically, the UE sends the access request message to the RAN node, to request to access the DCN node, where the access request message carries a type of a DCN that the UE requests to access.

Optionally, the UE may send an RRC connection setup complete (the RRC connection setup complete) message to the RAN node, where the RRC connection setup complete message carries a NAS (Non-access Stratum, non-access stratum) message and the DCN type (DCN Type). The NAS message is the access request message such as an attach (attach) message or a TAU (Tracking Area Update, tracking area update) message of the UE.

S308: The RAN node obtains, from the access request message, a type of a DCN that the UE requests to access.

Specifically, the RAN node obtains, from the access request message, the type of the DCN that the UE requests to access, determines, based on the type of the DCN that the UE requests to access, whether the DCN type is a DCN type on which congestion control currently needs to be performed, and if determining that the DCN type is the DCN type on which congestion control currently needs to be performed, the RAN node refuses the UE to access the requested DCN node, or if determining that the DCN type is not the DCN type on which congestion control currently needs to be performed, the RAN node allows the UE to access the requested DCN node.

S309: The RAN node determines a status of the DCN type based on the priority of the DCN type and the congestion grade.

Specifically, the RAN node may determine a status of each DCN type based on a priority of the DCN type and a congestion grade, where the status of the DCN type is a state of performing congestion control or a state of not performing congestion control. For example, the RAN node may determine a congestion control degree based on the congestion grade, sort the DCN types based on priorities of the DCN types, and determine the status of each DCN type based on a sorting result and the congestion control degree. For example, if the congestion control grade is low, the RAN node may determine that a status of a DCN type having a low priority is the state of performing congestion control, determine that statuses of DCN types having a high priority and an intermediate priority are the state of not performing congestion control, and allow access by UEs whose DCN types have the high priority and the intermediate priority. If the congestion control grade is high, the RAN node may determine that statuses of DCN types having a low priority and an intermediate priority are the state of performing congestion control, that is, reject access by UEs whose DCN types have the low priority and the intermediate priority, determine that a status of a DCN type having a high priority is the state of not performing congestion control, and allow access by UE whose DCN type has the high priority.

Optionally, after determining the status of each DCN type, the RAN node may store a correspondence between a DCN type and a status of the DCN type.

It should be understood that a specific congestion control execution manner depends on a preset network policy, and there are different execution manners based on different networks or different operators. However, a correspondence between a specific congestion control execution manner and a congestion grade falls with the protection scope of the present invention.

S310: The RAN node determines a status of the type of the DCN based on the type of the DCN.

Specifically, after the RAN node obtains the type of the DCN that the UE requests to access, the RAN node may obtain, based on the stored correspondence between a DCN type and a status of the DCN type, the status of the type of the to-be-accessed DCN that is requested.

S311: If the status of the type of the DCN is a state of not performing congestion control, the RAN node allows access by the UE.

Specifically, if the RAN node learns of that the status of the type of the to-be-accessed DCN that is requested is the state of not performing congestion control, the RAN node allows access by the UE.

S312: If the status of the type of the DCN is a state of performing congestion control, the RAN node does not allow access by the UE; or the RAN node obtains a priority of the UE based on the access request message, and determines, based on the priority of the UE, whether to allow access by the UE.

Specifically, if the RAN node learns of that the status of the type of the to-be-accessed DCN that is requested is the state of performing congestion control, the RAN node rejects access by the UE, and the RAN node sends a wireless connection release message to the UE, where a backoff time indication may be carried. The UE sets a backoff timer based on the backoff time indication, and after the timer expires, the UE applies for access again. When a core network determines to end congestion control, the DCN node may send a congestion control over (congestion control over) message to the RAN node, to instruct the RAN node to end congestion control.

Specifically, if the RAN node learns of that the status of the type of the to-be-accessed DCN that is requested is the state of performing congestion control, the RAN node may continue to obtain the priority of the UE (UE Priority) from the access request message sent by the UE, and determine whether to allow access by the UE based on the priority of the UE. For example, the UE adds a NAS message, the DCN type, and the priority of the UE to an RRC connection setup complete (RRC connection setup complete) message. The priority of the UE is a priority defined for the UE on a network, for example, a gold subscriber, a silver subscriber, or a bronze subscriber. The priority of the UE may be stored in a USIM (Universal Subscriber Identity Module, universal subscriber identity module), or stored in subscription data of an HSS (Home Subscriber Server, home subscriber server) during subscription registration. In this embodiment, the priority of the UE may be stored in the USIM and carried in an RRC message, and the RRC message is reported to the RAN node.

S313: The RAN node obtains a priority of UE by which access is allowed.

Specifically, after obtaining the priority of the UE, the RAN node obtains the preset priority of the UE by which access is allowed. In this embodiment of the present invention, for example, the priority of the UE by which access is allowed is a gold subscriber or a silver subscriber.

Optionally, the RAN node may pre-store the priority of the UE by which access is allowed, or obtain, from another network element device, the priority of the UE by which access is allowed.

S314: If the priority of the UE is greater than or equal to the priority of the UE by which access is allowed, the RAN node allows access by the UE.

Specifically, in this embodiment of the present invention, for example, the priority of the UE is a gold subscriber. The priority of the UE is a gold subscriber, the priority of the UE by which access is allowed is a gold subscriber or a silver subscriber, and the priority of the UE is greater than or equal to the priority of the UE by which access is allowed. Therefore, although the status of the type of the DCN that the UE requests to access is the state of performing congestion control, the RAN node also allows access by the UE.

S315: If the priority of the UE is less than the priority of the UE by which access is allowed, the RAN node does not allow access by the UE.

Specifically, in this embodiment of the present invention, for example, the priority of the UE is a bronze subscriber. The priority of the UE is a bronze subscriber, the priority of the UE by which access is allowed is a gold subscriber or a silver subscriber, and the priority of the UE is less than the priority of the UE by which access is allowed. Therefore, the RAN node does not allow access by the UE.

Optionally, if the RAN node determines to perform congestion control over current access by the UE, the RAN node sends a wireless connection release message to the UE, where a backoff time indication may be carried. The UE sets a backoff timer based on the backoff time indication, and after the timer expires, the UE applies for access again. When a core network determines to end congestion control, the DCN node may send a congestion control over message to the RAN node, to instruct the RAN node to end congestion control.

As can be learned from the above, a priority of a DCN type supported by the DCN node is defined. A congestion grade is determined based on a current network load status. When the entire DCN node is congested, congestion control may be first performed on the DCN type having a low priority on the network. Therefore, access by UE of the DCN type having a low priority is prevented, and normal access by UE of a DCN type having a high priority can be ensured, thereby improving resource usage.

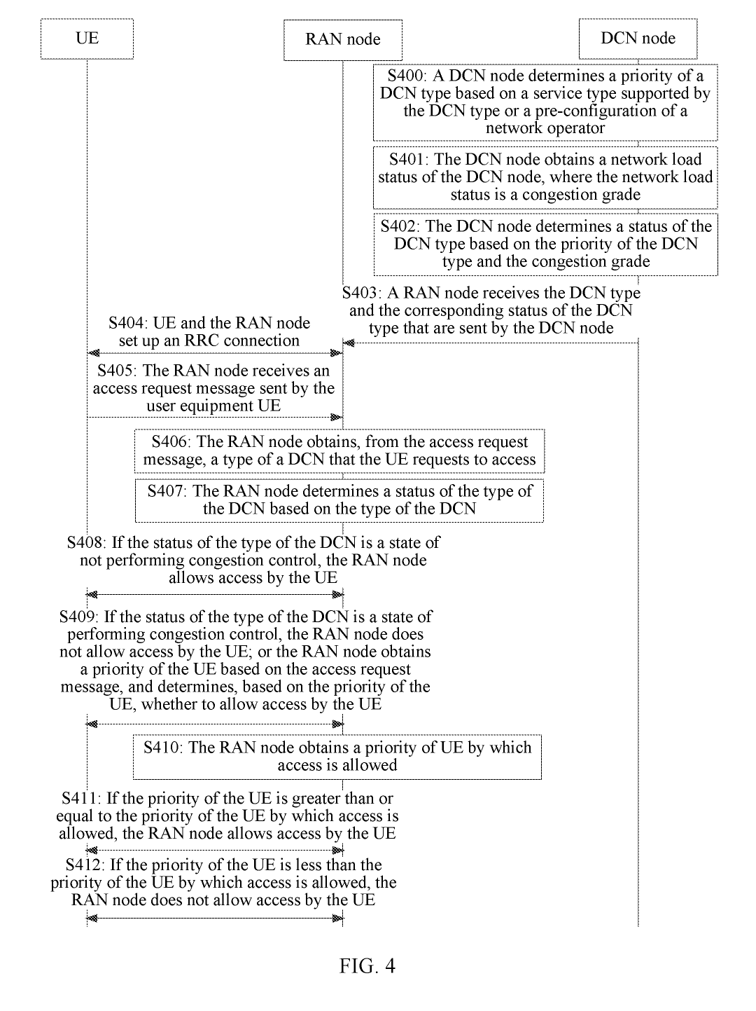

FIG. 4 is a schematic flowchart of a congestion control method according to a second embodiment of embodiments of the present invention. In the following embodiments, for ease of intuitive description, a type of a DCN node is referred to as a “DCN type” and is a UE type of UE served by the DCN node, and is used to indicate UEs having a same communications characteristic. A person skilled in the art shall understand that in the following embodiments, solutions obtained by replacing the DCN type with a UE type, a UE usage type, a UE service type, or one of all other names that can be used to indicate the UEs having a same communications characteristic are the same, and have an equivalent protection scope. It should be noted that one dedicated DCN node may simultaneously serve multiple types of UEs. Therefore, one DCN node may be of multiple DCN types.

A procedure of a congestion control method in this embodiment shown in FIG. 4 may include the following steps.

S400: A dedicated core network DCN node determines a priority of a DCN type based on a service type supported by the DCN type or a pre-configuration of a network operator.

Specifically, an implementation of step S400 in this embodiment is the same as that of step S300 in the embodiment of FIG. 3A and FIG. 3B. In this embodiment, details are not described again.

S401: The DCN node obtains a network load status of the DCN node, where the network load status is a congestion grade.

Specifically, an implementation of step S401 in this embodiment is the same as that of step S303 in the embodiment of FIG. 3A and FIG. 3B. In this embodiment, details are not described again.

S402: The DCN node determines a status of the DCN type based on the priority of the DCN type and the congestion grade.

During specific implementation, in this embodiment, the DCN node determines the status of the DCN type based on the priority of the DCN type and the congestion grade, and determines a DCN type over which congestion control needs to be performed. The status of the DCN type is a state of performing congestion control or a state of not performing congestion control. For example, the DCN node may determine a congestion control degree based on the congestion grade, sort DCN types based on priorities of the DCN types, and determine a status of each DCN type based on a sorting result and the congestion control degree. For example, if the congestion control grade is low, the DCN node may determine that a status of a DCN type having a low priority is the state of performing congestion control, and determine that statuses of DCN types having a high priority and an intermediate priority are the state of not performing congestion control. If the congestion control grade is high, the DCN node may determine that statuses of DCN types having a low priority and an intermediate priority are the state of performing congestion control, that is, reject access by UEs whose DCN types have the low and intermediate priorities, determine that a status of a DCN type having a high priority is the state of not performing congestion control, and allow access by UE whose DCN type has the high priority.

Optionally, after the DCN node determines the status of each DCN type, the DCN node may store a correspondence between a DCN type and a status of the DCN type.

It should be noted that a specific congestion control execution manner depends on a preset network policy, and there are different execution manners based on different networks or different operators. However, a correspondence between a specific congestion control execution manner and a congestion grade falls with the protection scope of the present invention.

S403: A RAN node receives the DCN type and the corresponding status of the DCN type that are sent by the DCN node.

Specifically, the DCN node sends congestion control start information to the RAN node. The congestion control start information includes each DCN type and a corresponding status of the DCN type. The status of the DCN type is the state of performing congestion control or the state of not performing congestion control. The RAN node may store a correspondence between each DCN type and the corresponding status of the DCN type.

Optionally, the congestion control start information may include only a DCN type or a list of DCN types over which congestion control needs to be performed. The list of DCN types stores DCN types whose statuses are the state of performing congestion control.

Optionally, in addition to the DCN type or the list of DCN types over which congestion control needs to be performed, the congestion control start information may further include a DCN type or a list of DCN types over which congestion control does not need to be performed. The list of DCN types over which congestion control does not need to be performed stores DCN types whose statuses are the state of not performing congestion control.

Optionally, when a network congestion status changes, the DCN node may further send a congestion control modification message to dynamically update the status of the DCN type, for example, update the DCN type over which congestion control needs to be performed.

The DCN node may send a congestion control modify (congestion control modify) message to the RAN node. DCN types included in the message indicate updated DCN types or a list of updated DCN types over which congestion control needs to be performed.

S404: UE and the RAN node set up an RRC connection.

S405: The RAN node receives an access request message sent by the user equipment UE.

S406: The RAN node obtains, from the access request message, a type of a DCN that the UE requests to access.

Specifically, an implementation of steps S404 to S406 in this embodiment is the same as that of steps S306 to S308 in the embodiment of FIG. 3A and FIG. 3B. In this embodiment, details are not described again.

S407: The RAN node determines a status of the type of the DCN based on the type of the DCN.

S408: If the status of the type of the DCN is a state of not performing congestion control, the RAN node allows access by the UE.

S409: If the status of the type of the DCN is a state of performing congestion control, the RAN node does not allow access by the UE; or the RAN node obtains a priority of the UE based on the access request message, and determines, based on the priority of the UE, whether to allow access by the UE.

S410: The RAN node obtains a priority of UE by which access is allowed.

S411: If the priority of the UE is greater than or equal to the priority of the UE by which access is allowed, the RAN node allows access by the UE.

S412: If the priority of the UE is less than the priority of the UE by which access is allowed, the RAN node does not allow access by the UE.

Specifically, an implementation of steps S407 to S412 in this embodiment is the same as that of steps S310 to S315 in the embodiment of FIG. 3A and FIG. 3B. In this embodiment, details are not described again.

As can be learned from the above, a priority of a DCN type supported by the DCN node is defined. A congestion grade is determined based on a current network load status. When the entire DCN node is congested, congestion control may be first performed on the DCN type having a low priority on a network. Therefore, access by UE of the DCN type having a low priority is prevented, and normal access by UE of a DCN type having a high priority can be ensured, thereby improving resource usage.

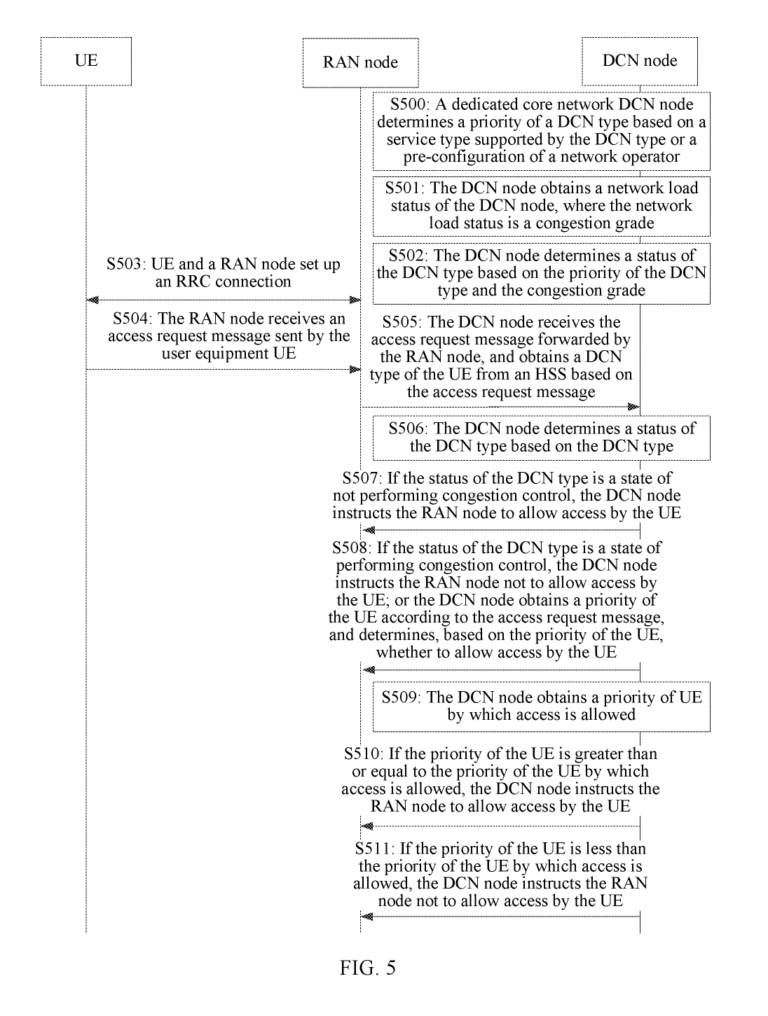

FIG. 5 is a schematic flowchart of a congestion control method according to a third embodiment of embodiments of the present invention. In the following embodiments, for ease of intuitive description, a type of a DCN node is referred to as a “DCN type” and is a UE type of UE served by the DCN node, and is used to indicate UEs having a same communications characteristic. A person skilled in the art shall understand that in the following embodiments, solutions obtained by replacing the DCN type with a UE type, a UE usage type, a UE service type, or one of all other names that can be used to indicate the UEs having a same communications characteristic are the same, and have an equivalent protection scope. It should be noted that one dedicated DCN node may simultaneously serve multiple types of UEs. Therefore, one DCN node may be of multiple DCN types.

A procedure of a congestion control method in this embodiment shown in FIG. 5 may include the following steps.

S500: A dedicated core network DCN node determines a priority of a DCN type based on a service type supported by the DCN type or a pre-configuration of a network operator.

Specifically, an implementation of step S500 in this embodiment is the same as that of step S300 in the embodiment of FIG. 3A and FIG. 3B. In this embodiment, details are not described again.

S501: The dedicated core network DCN node obtains a network load status of the DCN node, where the network load status is a congestion grade.

Specifically, an implementation of step S501 in this embodiment is the same as that of step S303 in the embodiment of FIG. 3A and FIG. 3B. In this embodiment, details are not described again.

S502: The DCN node determines a status of the DCN type based on the priority of the DCN type and the congestion grade.

Specifically, an implementation of step S502 in this embodiment is the same as that of step S402 in the embodiment of FIG. 4. In this embodiment, details are not described again.

S503: UE and a RAN node set up an RRC connection.

S504: The RAN node receives an access request message sent by the user equipment UE.

Specifically, an implementation of steps S503 and S504 in this embodiment is the same as that of steps S306 and S307 in the embodiment of FIG. 3A and FIG. 3B. In this embodiment, details are not described again.

S505: The DCN node receives the access request message forwarded by the RAN node, and obtains a DCN type of the UE from an HSS based on the access request message.

Specifically, in this embodiment of the present invention, the UE is allowed not to add the DCN type of the UE or other similar dedicated network selection auxiliary information to an RRC message (backward-compatible with an R-13 terminal). The DCN node may obtain the DCN type of the UE based on a NAS message of the UE. The DCN node may obtain the DCN type of the UE from the HSS (Home Subscriber Server, home subscriber server) based on the NAS message of the UE.

Optionally, the DCN node obtains the DCN type of the UE in manners including but not limited to the following four manners: (1) After the DCN node receives the NAS message of the UE forwarded by the RAN node, the DCN node may obtain subscription data of the UE from the HSS based on an identifier of the UE, where the subscription data of the UE includes a usage type (Usage Type) of the UE, and obtain the DCN type of the UE based on a correspondence between the usage type and the DCN type of the UE. (2) The UE may directly add a usage type information element of the UE to the NAS message, and the DCN node obtains the DCN type of the UE from the HSS based on a correspondence between a usage type and the DCN type of the UE. (3) Alternatively, the UE may directly add a DCN type information element of the UE to the NAS message. (4) The NAS message sent by the UE includes a permanent identifier or a temporary identifier of the UE, where the permanent identifier or the temporary identifier of the UE includes the DCN type of the UE, and the DCN node may parse the permanent identifier or the temporary identifier of the UE to obtain the DCN type.

S506: The DCN node determines a status of the DCN type based on the DCN type.

Specifically, the DCN node determines the corresponding status of the DCN type based on the DCN type of the UE obtained in the foregoing step.

Optionally, the DCN node may obtain, based on a stored correspondence between a DCN type and a status of the DCN type, a status of a type of a DCN that the UE requests to access.

S507: If the status of the DCN type is a state of not performing congestion control, the DCN node instructs the RAN node to allow access by the UE.

Specifically, if the RAN node learns of that the status of the type of the to-be-accessed DCN that is requested is the state of not performing congestion control, the DCN node sends an access permission notification to the RAN node, so that the RAN node allows, based on the notification, access by the UE.

S508: If the status of the DCN type is a state of performing congestion control, the DCN node instructs the RAN node not to allow access by the UE; or the DCN node obtains a priority of the UE based on the access request message, and determines, based on the priority of the UE, whether to allow access by the UE.

Specifically, if the DCN node learns of that the status of the type of the to-be-accessed DCN that is requested is the state of performing congestion control, the DCN node does not allow access by the UE, and the DCN node may send a request rejection message to the RAN node, where a cause value is carried to indicate that current access rejection is caused by congestion control. After receiving the request rejection message sent by the DCN node, the RAN node sends a wireless connection release message to the UE, where a backoff time indication may be carried. The UE sets a backoff timer based on the backoff time indication, and after the timer expires, the UE applies for access again. When a core network determines to end congestion control, the DCN node may send a congestion control over message to the RAN node, to instruct the RAN node to end congestion control.

Specifically, if the DCN node learns of that the status of the type of the to-be-accessed DCN that is requested is the state of performing congestion control, the DCN node may continue to obtain the priority of the UE (UE Priority) from the access request message sent by the UE, and determine, based on the priority of the UE, whether to allow access by the UE. For example, the UE adds a NAS message and the priority of the UE to an RRC connection setup complete (RRC connection setup complete) message. The priority of the UE is a priority defined for the UE on a network, for example, a gold subscriber, a silver subscriber, or a bronze subscriber. The priority of the UE may be stored in a USIM, or stored in subscription data of the HSS during subscription registration. In this embodiment, the priority of the UE may be stored in the USIM and carried in an RRC message, and the RRC message is reported to the RAN node. The RAN node forwards the RRC message to the DCN node.

S509: The DCN node obtains a priority of UE by which access is allowed.

Specifically, after the DCN node obtains the priority of the UE, the DCN node obtains the preset priority of the UE by which access is allowed. In this embodiment of the present invention, for example, the priority of the UE by which access is allowed is a gold subscriber or a silver subscriber.

Optionally, the DCN node may pre-store the priority of the UE by which access is allowed, or obtain, from another network element device, the priority of the UE by which access is allowed.

S510: If the priority of the UE is greater than or equal to the priority of the UE by which access is allowed, the DCN node instructs the RAN node to allow access by the UE.

Specifically, in this embodiment of the present invention, for example, the priority of the UE is a gold subscriber. The priority of the UE is a gold subscriber, the priority of the UE by which access is allowed is a gold subscriber or a silver subscriber, and the priority of the UE is greater than or equal to the priority of the UE by which access is allowed. Therefore, although the status of the type of the DCN that the UE requests to access is the state of performing congestion control, the DCN node allows access by the UE. The DCN node sends an access permission notification to the RAN node, so that the RAN node allows, based on the notification, access by the UE.

S511: If the priority of the UE is less than the priority of the UE by which access is allowed, the DCN node instructs the RAN node not to allow access by the UE.

Specifically, in this embodiment of the present invention, for example, the priority of the UE is a bronze subscriber. The priority of the UE is a bronze subscriber, the priority of the UE by which access is allowed is a gold subscriber or a silver subscriber, and the priority of the UE is less than the priority of the UE by which access is allowed. Therefore, the DCN node does not allow access by the UE.

Optionally, if the DCN node determines to perform congestion control over current access by the UE, the DCN node sends a request rejection message to the RAN node, where a cause value is carried to indicate that current access rejection is caused by congestion control. The RAN node sends a wireless connection release message to the UE based on the request rejection message sent by the DCN node, where a backoff time indication may be carried. The UE sets a backoff timer based on the backoff time indication, and after the timer expires, the UE applies for access again. When a core network determines to end congestion control, the DCN node may send a congestion control over message to the RAN node, to instruct the RAN node to end congestion control.

As can be learned from the above, a congestion control method for a dedicated network is provided. The DCN node performs a congestion control policy, and the method may be backward-compatible with UE and a RAN node that support only R-13 DECOR. The DCN node performs congestion control at a granularity of a DCN based on a congestion control grade and the priority of the DCN type, and normal access for a DCN type having a high priority is ensured, thereby improving resource usage.

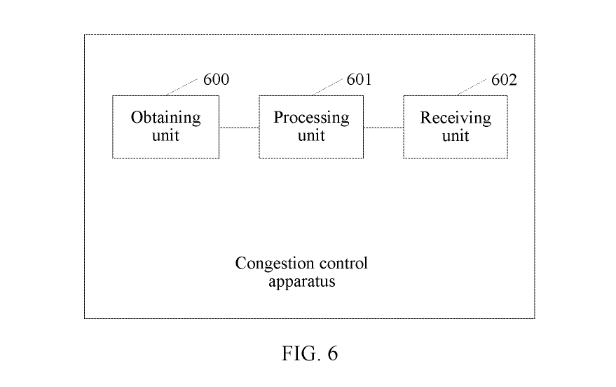

Referring to FIG. 6, FIG. 6 is a schematic structural diagram of a congestion control apparatus according to an embodiment of the present invention. The congestion control apparatus shown in FIG. 6 includes an obtaining unit 600, a processing unit 601, and a receiving unit 602.

The obtaining unit 600 is configured to obtain a priority of a dedicated core network DCN type.

The processing unit 601 is configured to determine a status of the DCN type based on the priority of the DCN type, where the status of the DCN type is a state of performing congestion control or a state of not performing congestion control.

The receiving unit 602 is configured to receive an access request message sent by user equipment UE.

The obtaining unit 600 is further configured to obtain, based on the access request message, a type of a DCN that the UE requests to access.

The processing unit 601 is further configured to: learn of a status of the type of the DCN that the UE requests to access, and determine, based on the status of the type of the DCN that the UE requests to access, whether to allow access by the UE.

Optionally, the processing unit 601 is specifically configured to:

obtain a network load status, and determine the status of the DCN type based on the priority of the DCN type and the network load status.

Optionally, the network load status is a congestion grade, and the processing unit 601 is specifically configured to:

determine the status of the DCN type based on the priority of the DCN type and the congestion grade.

Optionally, the congestion control apparatus is integrated in a radio access network RAN node.

Optionally, when the congestion control apparatus is integrated in the RAN node, the processing unit 601 is specifically configured to: receive the network load status sent by a DCN node. The foregoing functional units are configured to perform related steps of steps S304 and S305 in the embodiment of FIG. 3A and FIG. 3B.

Optionally, when the congestion control apparatus is integrated in the RAN node, the obtaining unit 600 is specifically configured to: determine the priority of the DCN type based on a service type supported by the DCN type or a pre-configuration of an operator; or determine the priority of the DCN type based on DCN information sent by the DCN node. The foregoing functional units are configured to perform related steps of step S300 in the embodiment of FIG. 3A and FIG. 3B, step S400 in FIG. 4, step S500 in the embodiment of FIG. 5, and step S301 in FIG. 3A and FIG. 3B.

Optionally, the obtaining unit 600 is specifically configured to obtain, from the access request message, the type of the DCN that the UE requests to access. The foregoing functional units are configured to perform related steps of step S308 in the embodiment of FIG. 3A and FIG. 3B and step S406 in FIG. 4.

Optionally, the congestion control apparatus is integrated in a DCN node.

Optionally, when the congestion control apparatus is integrated in the DCN node, the processing unit 601 is specifically configured to: obtain the network load status of the DCN node. The foregoing functional units are configured to perform related steps of step S303 in the embodiment of FIG. 3A and FIG. 3B, step S401 in the embodiment of FIG. 4, and step S501 in the embodiment of FIG. 5.

Optionally, when the congestion control apparatus is integrated in the DCN node, the obtaining unit 600 is specifically configured to: obtain, from the access request message, the type of the DCN that the UE requests to access; or obtain the DCN type of the UE from a home subscriber server HSS based on the access request message. The foregoing functional units are configured to perform related steps of step S308 in the embodiment of FIG. 3A and FIG. 3B, step S406 in FIG. 4, and step S505 in FIG. 5.

Optionally, when the congestion control apparatus is integrated in the DCN node, the obtaining unit 600 is specifically configured to: determine the priority of the DCN type based on a service type supported by the DCN type or a pre-configuration of a network operator. The foregoing functional units are configured to perform related steps of step S300 in the embodiment of FIG. 3A and FIG. 3B, step S400 in FIG. 4, and step S500 in the embodiment of FIG. 5.

Optionally, the processing unit 601 is specifically configured to: if the status of the type of the DCN is the state of not performing congestion control, allow access by the UE; or if the status of the type of the DCN is the state of performing congestion control, skip allowing access by the UE.

Optionally, the processing unit 601 is specifically configured to: if the status of the type of the DCN is the state of performing congestion control, obtain a priority of the UE based on the access request message, and determine, based on the priority of the UE, whether to allow access by the UE.

Optionally, the processing unit 601 is specifically configured to: obtain a priority of UE by which access is allowed; and if the priority of the UE is greater than or equal to the priority of the UE by which access is allowed, allow access by the UE; or if the priority of the UE is less than the priority of the UE by which access is allowed, skip allowing access by the UE.

The foregoing functional units are configured to perform related steps of steps S312 to S315 in the embodiment of FIG. 3A and FIG. 3B, steps S409 to S412 in FIG. 4, and steps S508 to S512 in the embodiment of FIG. 5.

An embodiment of the present invention further provides a computer storage medium, configured to store a computer software instruction used by the congestion control apparatus shown in FIG. 6. The computer software instruction includes a program designed to implement the foregoing method embodiments. During implementation of the foregoing method, access by UE of a DCN type having a low priority can be prevented, and normal access by UE of a DCN type having a high priority can be ensured. In addition, it can be avoided that a DCN node monitors a load status of each supported DCN type, thereby reducing policy complexity of the DCN node. Furthermore, it is avoided that the DCN node is not congested but a particular type of DCN is congested, thereby improving resource usage.

With descriptions of the foregoing implementations, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a ROM, an EEPROM, a CD-ROM or another optical disc storage, a disk storage medium or another magnetic storage device, or any other medium that can carry or store expected program code in a form of an instruction or a data structure and that can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk (Disk) and disc (disc) used by the present invention includes a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

What are disclosed above are merely example embodiments of the present invention, and certainly are not intended to limit the protection scope of the present invention. Therefore, equivalent variations made in accordance with the claims of the present invention shall fall within the scope of the present invention.

What is claimed is:

1. A congestion control method, applied to a dedicated core network (DCN) scenario, and comprising:
obtaining a priority of a dedicated core network DCN type;
determining a status of the DCN type based on the priority of the DCN type, wherein the status of the DCN type is a state of performing congestion control or a state of not performing congestion control;
receiving an access request message sent by user equipment (UE);
obtaining, based on the access request message, a type of a DCN that the UE requests to access; and
learning of a status of the type of the DCN that the UE requests to access, and determining, based on the status of the type of the DCN that the UE requests to access, whether to allow access by the UE.

2. The method according to claim 1, wherein the determining a status of the DCN type based on the priority of the DCN type comprises:
obtaining a network load status, and determining the status of the DCN type based on the priority of the DCN type and the network load status.

3. The method according to claim 2, wherein the network load status is a congestion grade, and the determining the status of the DCN type based on the priority of the DCN type and the network load status comprises:
determining the status of the DCN type based on the priority of the DCN type and the congestion grade.

4. The method according to claims 1, wherein the method is performed by a radio access network (RAN) node.

5. The method according to claim 4, wherein the obtaining a network load status comprises:
receiving, by the radio access network RAN node, the network load status sent by a DCN node.

6. The method according to claim 4, wherein the obtaining a priority of a dedicated core network DCN type comprises:
determining, by the RAN node, the priority of the DCN type based on a service type supported by the DCN type or a pre-configuration of an operator; or determining, by the RAN node, the priority of the DCN type based on DCN information sent by the DCN node.

7. The method according to claim 4, wherein the obtaining, based on the access request message, a type of a DCN that the UE requests to access comprises:
obtaining, from the access request message, the type of the DCN that the UE requests to access.

8. The method according to claim 1, wherein the method is performed by a DCN node.

9. The method according to claim 8, wherein the obtaining a network load status comprises:
obtaining, by the DCN node, the network load status of the DCN node.

10. The method according to claim 8, wherein the obtaining, based on the access request message, a type of a DCN that the UE requests to access comprises:
obtaining, by the DCN node from the access request message, the type of the DCN that the UE requests to access, or obtaining, by the DCN node, the DCN type of the UE from a home subscriber server HSS based on the access request message.

11. The method according to claim 8, wherein when the method is performed by the DCN node, the obtaining a priority of a dedicated core network DCN type comprises:
determining, by the DCN node, the priority of the DCN type based on a service type supported by the DCN type or a pre-configuration of a network operator.

12. The method according to claim 1, wherein the determining, based on the status of the type of the DCN that the UE requests to access, whether to allow access by the UE comprises:
if the status of the type of the DCN is the state of not performing congestion control, allowing access by the UE; or
if the status of the type of the DCN is the state of performing congestion control, skipping allowing access by the UE.

13. A congestion control apparatus, applied to a dedicated core network DCN scenario, and comprising:
a processor, configured to obtain a priority of a dedicated core network DCN type, wherein
the processor is further configured to determine a status of the DCN type based on the priority of the DCN type, wherein the status of the DCN type is a state of performing congestion control or a state of not performing congestion control; and
a receiver, configured to receive an access request message sent by user equipment UE, wherein
the processor is further configured to obtain, based on the access request message, a type of a DCN that the UE requests to access; and
the processor is further configured to: learn of a status of the type of the DCN that the UE requests to access, and determine, based on the status of the type of the DCN that the UE requests to access, whether to allow access by the UE.

14. The congestion control apparatus according to claim 13, wherein the determining, by the processor, a status of the DCN type based on the priority of the DCN type comprises:
obtaining a network load status, and determining the status of the DCN type based on the priority of the DCN type and the network load status.

15. The congestion control apparatus according to claim 14, wherein the network load status is a congestion grade, and the determining, by the processor, the status of the DCN type based on the priority of the DCN type and the network load status comprises:
determining the status of the DCN type based on the priority of the DCN type and the congestion grade.

16. The congestion control apparatus according to claim 13, wherein the congestion control apparatus is integrated in a radio access network RAN node.

17. The congestion control apparatus according to claim 16, wherein when the congestion control apparatus is integrated in the RAN node, the obtaining, by the processor, a network load status comprises:
receiving the network load status sent by a DCN node.

18. The congestion control apparatus according to claim 16, wherein when the congestion control apparatus is integrated in the RAN node, the obtaining, by a processor, a priority of a dedicated core network DCN type comprises:
determining the priority of the DCN type based on a service type supported by the DCN type or a pre-configuration of an operator; or
determining the priority of the DCN type based on DCN information sent by the DCN node.

19. The congestion control apparatus according to claim 16, wherein the obtaining, by the processor based on the access request message, a type of a DCN that the UE requests to access comprises:
obtaining, from the access request message, the type of the DCN that the UE requests to access.

20. The congestion control apparatus according to claim 13, wherein the congestion control apparatus is integrated in a DCN node.
